(19) United States
(12) Patent Application Publication
(10) Pub. No.: US 2025/0216254 A1
(43) Pub. Date: Jul. 3, 2025

(54) DIFFRACTIVE EUV SPECTRAL PURITY FILTERS FOR OPTICAL SYSTEMS

(71) Applicant: KLA Corporation, Milpitas, CA (US)

(72) Inventors: Alon Rosenthal, Weston, CT (US); Rajeev Rajendran, San Francisco, CA (US); Farid Atry, San Jose, CA (US); Yun Xie, Pudong (CN); Rui-Fang Shi, Cupertino, CA (US)

(21) Appl. No.: 18/990,783

(22) Filed: Dec. 20, 2024

Related U.S. Application Data
(60) Provisional application No. 63/617,080, filed on Jan. 3, 2024.

(51) Int. Cl. G01J 3/02; G01J 3/28

(52) U.S. Cl. CPC G01J 3/0229; G01J 3/2823; G01J 2003/2826

(57) ABSTRACT

A reflective imaging system disclosed herein includes an illumination source for generating a broad wavelength extreme ultraviolet (EUV) illumination beam, a reflective spectral filter for spectrally filtering the EUV illumination beam to direct spectrically filtered EUV light along a first optical path and reflect out-of-band (OOB) light along a second optical path, one or more detectors to detect the reflected spectrally filtered EUV light and OOB light, and a controller configured to obtain light data from the one or more detectors. The present disclosure further provides a method of spectrally filtering broad wavelength EUV light and embodiments of grating based EUV spectral filters.

### CROSS REFERENCE TO RELATED APPLICATION

The present application claims the benefit of U.S. Provisional Application No. 63/617,080, filed Jan. 3, 2024, the disclosure of which is hereby incorporated by reference.

### TECHNICAL FIELD

The present disclosure relates generally to extreme ultraviolet (EUV) spectral filtering, and more particularly, to reflective spectral filters including diffraction gratings for separating out-of-band (OOB) light from EUV light, and reflection based optical systems including reflective spectral filters.

### BACKGROUND

Lithography processes and various inspection and optical systems use extreme ultraviolet (EUV) light to achieve smaller desired feature sizes. Such processes and systems require spectral filtering to isolate a narrow wavelength range of the EUV light, for instance 10-15 nm and typically about 13.5 nm for EUV lithography. Traditional plasma EUV light sources inherently emit light spanning a wide wavelength range. As such, plasma EUV light sources emit undesirable longer wavelengths of light such as infrared (IR), ultraviolet (UV) and visible light, collectively referred to as out-of-band (OOB) light, that must be suppressed.

To intercept or suppress OOB light that may be nuisance light or harmful to a target substrate such as a wafer, spectral purity filters (SPFs) are used to absorb the OOB light while allowing the EUV light to pass through for downstream use. While effective at absorbing OOB light, spectral filters such as thin film zirconium filters are delicate, have a limited use life due to absorption induced damage, and increase complexity of optical systems. In addition, by absorbing the OOB light, the OOB light absorbed cannot be measured, which may be useful data in some applications.

Therefore, it is desirable to provide filter solutions that overcome the shortcomings of previous approaches outlined above.

### SUMMARY

According to a first aspect of the present disclosure, a reflective imaging system includes an illumination source configured to generate an extreme ultraviolet (EUV) illumination beam, a reflective spectral filter configured to receive the EUV illumination beam and spectrally filter the received EUV illumination beam by reflecting spectrically filtered EUV light along a first optical path and reflecting out-of-band (OOB) light along a second optical path, one or more first detectors positioned in an image plane of the first optical path configured to detect the spectrally filtered EUV light, one or more second detectors positioned in an image plane of the second optical path configured to detect the OOB light, and a controller communicatively coupled to the one or more first detectors and the one or more second detectors, the controller including one or more processors configured to receive data pertaining to the detected spectrally filtered EUV light and the detected OOB light.

According to another aspect of the present disclosure, a method for spectrally filtering extreme ultraviolet (EUV) light includes receiving by a reflective spectral filter EUV light from an EUV illumination beam, separating by the reflective spectral filter the EUV light into spectrally filtered EUV light and out-of-band (OOB) light, reflecting by the reflective spectral filter the spectrally filtered EUV light along a first optical path and the OOB light along a second optical path, detecting by at least one first detector positioned in an image plane of the first optical path the EUV light reflected along the first optical path, and detecting by at least one second detector positioned in an image plane of the second optical path the OOB light reflected along the second optical path.

According to a further aspect of the present disclosure, a reflective spectral filter configured to spectrally separate out-of-band (OOB) light from a plasma extreme ultraviolet (EUV) illumination beam includes a substrate, a multilayer stack positioned on the substrate, and a capping layer positioned on the multilayer stack, wherein at least one of the substrate and the multilayer stack comprises a binary grating having a preselected depth and preselected pitch configured to reflect spectrally filtered EUV light along a first optical path and reflect the OOB light along a second optical path.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 is a schematic diagram illustrating a reflective optical system, in accordance with one or more embodiments of the present disclosure.

FIG. 2 is a schematic diagram illustrating a mask inspection system including a reflective EUV spectral filter disposed in the illuminator, in accordance with one or more embodiments of the present disclosure.

FIG. 3 is a schematic diagram illustrating a mask inspection system including a reflective EUV spectral filter disposed at the pupil imager, in accordance with one or more embodiments of the present disclosure.

FIG. 4 is a schematic diagram illustrating the filtering concept (e.g., wavelength separation) of a reflective EUV spectral filter, in accordance with one or more embodiments of the present disclosure.

FIG. 5 is a schematic diagram illustrating another embodiment of the reflective EUV spectral filter including an absorber layer, in accordance with one or more embodiments of the present disclosure.

FIG. 6 is a schematic diagram illustrating a further embodiment of the reflective EUV spectral filter including an etched substrate, in accordance with one or more embodiments of the present disclosure.

FIG. 7 is a schematic diagram illustrating a further embodiment of the reflective EUV spectral filter including an EUV refractory material, in accordance with one or more embodiments of the present disclosure.

FIG. 8 is a flow chart illustrating a method for spectrally filtering EUV light, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

The present disclosure is directed to extreme ultraviolet (EUV) reflective optics (also grating based spectral purity filter (SPF), reflective SPF or and diffractive SPF) for use in reflection-based optical systems such as, but not limited to, inspection systems (e.g., masks and reticles), optical imaging systems, lithography systems, defect detection systems, metrology systems, etc. In embodiments, the diffractive spectral purity filters disclosed herein function to separate out-of-band (OOB) light by reflecting light along different pathways based on wavelength. In this regard, light having a desired wavelength may be reflected along a first pathway and passed further into a system, whereas OOB light not of the desired wavelength(s) may be reflected along a different pathway, for instance to a detector for measuring the OOB light. In embodiments, the reflective spectral filters disclosed herein may be configured to separate OOB light (e.g., 15-1000 nm) from wide wavelength EUV light to provide spectrally filtered or “pure” EUV light (e.g., 10-15 nm) for use in such systems requiring extraneous OOB light suppression. In embodiments, spectrally filtered EUV light having a narrow and desired wavelength range is provided for use in, for example, an EUV lithography system, whereas the OOB light may be isolated, reflected, detected, measured, etc.

In embodiments, the EUV reflective optics disclosed herein may be used in EUV lithography systems including a source of EUV light, condenser optics, a reticle mask, and an optical system including at least one EUV reflective optic (e.g., mirror) configured to reflect EUV light by means of a multilayer stack (e.g., molybdenum and silicon). EUV light sources may include plasma EUV light sources, among other light sources. In embodiments, the reflective spectral filters disclosed herein include diffraction gratings for filtering out ‘undesirable’ wavelengths (e.g., OOB light) by diffracting the spectrally filtered EUV light and OOB light along separate optical paths based on wavelength. In embodiments, the reflective spectral filters may be separate components of the system or may be incorporated into other system components, for instance mirrors.

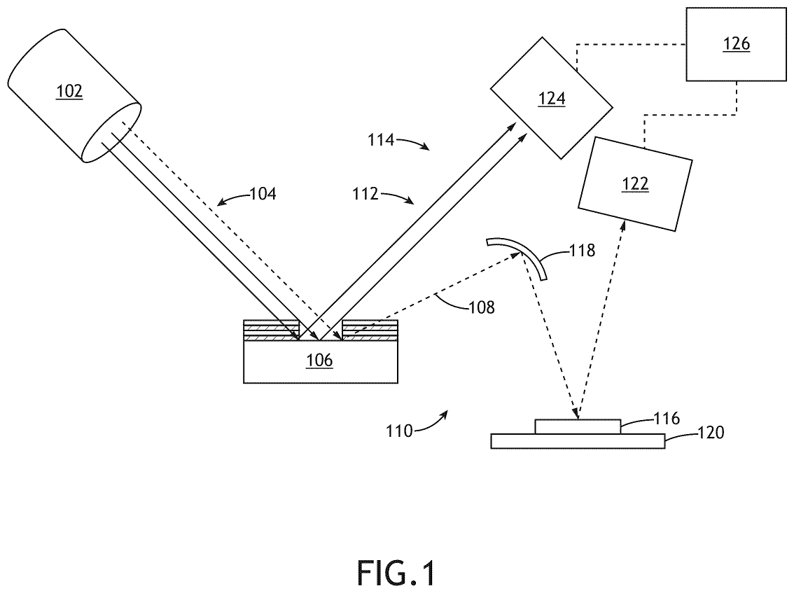

FIG. 1 is a schematic diagram illustrating a reflective optical system 100, in accordance with one or more embodiments of the present disclosure. In embodiments, the system 100 may include an illumination source 102 configured to generate an extreme ultraviolet (EUV) illumination beam 104. In embodiments, the EUV illumination beam 104 may be generated by a laser-sustained plasma source configured to output broadband light having a broad wavelength range including, for example, EUV light (e.g., 10-15 nm) and longer wavelength light (e.g., 20-1000 nm).

In embodiments, one or more reflective EUV spectral filters 106 may be configured to receive and reflect the EUV illumination beam 104. In embodiments, the reflective EUV spectral filter 106 may be configured to spectrally filter the received EUV illumination beam 104 by reflecting spectrically filtered EUV light 108 along a first optical path 110, and reflecting out-of-band (OOB) light 112 along a second optical path 114. In embodiments, the first optical path 110 may correspond to the +1^{st} and higher orders whereas the second optical path may correspond to the 0^{th} order. In embodiments, the −1^{st} and lower orders may be lost, or depending on the configuration, may correspond to an evanescent mode.

In embodiments, spectrically filtered EUV light 110 may be directed to a target substrate 116 to be illuminated by the EUV light, either directly or via at least one downstream optic 118, such as a focusing mirror, or other optical component. In embodiments, the target substrate 116 may be positioned on a translation stage 120 configured to translate the target substrate 116 scanned by the EUV light 108. In another system configuration, the illumination beam 104 may be directed to illuminate the target substrate 116, and the light reflected from the target substrate 116 may be received and reflected by the reflective EUV spectral filter 106 configured to reflect the separated light wavelengths along separate first and second collection paths. In embodiments, the system 110 may include a plurality of reflective EUV spectral filters each configured to separate a wavelength range of the OOB light according a progressive wavelength filtering scheme.

In embodiments, one or more first detectors 122 may be positioned in the image plane of the first optical path 110 configured to detect the spectrally filtered EUV light 108, either directly or reflected from the target substrate 116. Likewise, one or more second detectors 124 may be positioned in the image plane of the second optical path 114 configured to detect the OOB light 112. In embodiments, the one or more first detectors 122 (e.g., sensors or photodetectors) may be a time-delay integration detector array configured to detect light data as the target substrate 116 is scanned.

In embodiments, the system 100 may further include a controller 126, including one or more processors, a memory, input/output devices, etc., communicatively coupled to the one or more first detectors 122 and the one or more second detectors 124. In embodiments, the controller 126 may be configured to receive data associated with the EUV spectrally filtered light 108, such as light reflected from the target sample 116, and the OOB light 112. The controller 126 may operate to receive and process light data to, for example, measure the light data, analyze the light data, perform pattern inspections, defect detection, etc.

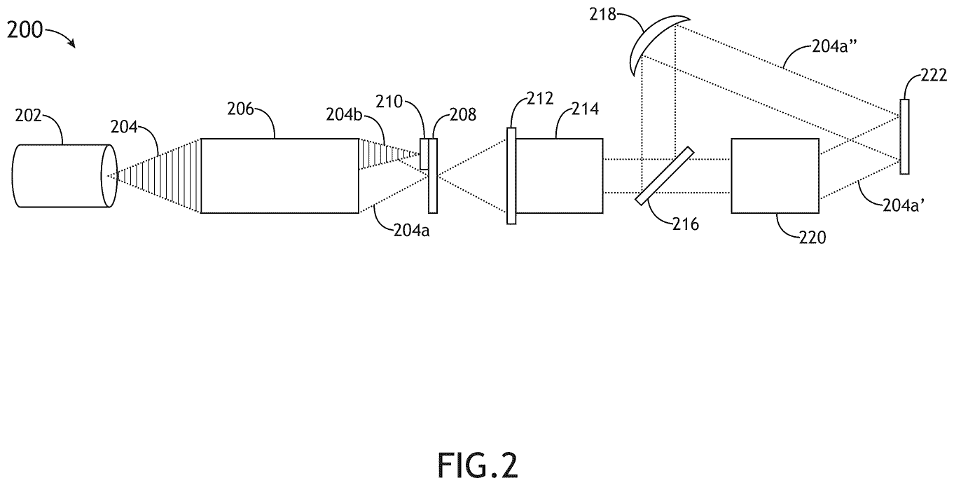

FIG. 2 is a schematic diagram illustrating an embodiment of a mask inspection system 200 according to the present disclosure. In embodiments, the mask inspection system 200 includes an illumination source configured to generate a broad wavelength EUV beam 204 (i.e., including desired EUV wavelength range and OOB wavelengths), and a collector 206 for handling the illumination beam 204. In the embodiment shown, a reflective EUV spectral filter 106 as described herein is incorporated in the collector 206 and filters the light such that spectrically filtered EUV light is reflected along a first path 204a to illuminate a target portion of a mask 208, and the OOB light is reflected along a second path 204b to illuminate a detector 210. In embodiments, the filtered EUV light 204a is directed downstream through an imaging aperture 212 associated with downstream imaging optics 214, 220, pupil relay mirrors 216, 218, etc. for beam handling along collection channels 204a′, 204a″ before finally being detected by an image sensor 222. In embodiments, the mask inspection system 200 can include a controller configured to analyze the image for mask defects as well as measure the OOB light.

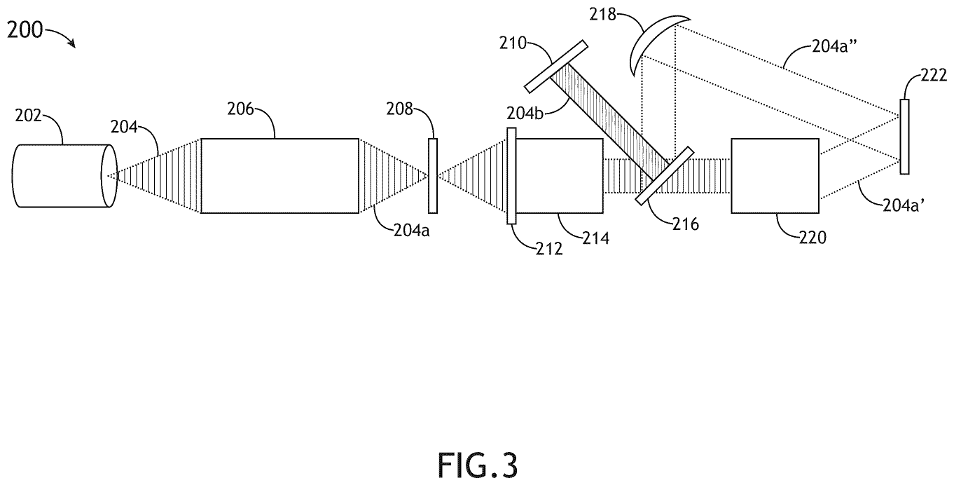

FIG. 3 is a schematic diagram illustrating a modification to the mask inspection system 200. In embodiments, the broad wavelength EUV beam 204 from the illumination source 202 passes unfiltered through the collector 206 for illuminating a target portion of the mask 208 for inspection, with the mask 208 being reflective and not transmissive. The broad wavelength EUV beam 204 is directed through the imaging aperture 212 associated with the imaging optics 214. In this embodiment, the reflective EUV filter 106 as described herein is disposed downstream of the first set of imaging optics 214 in order to separate the beam into the spectrally filtered EUV light that continues along a first path to the image sensor, and the OOB light reflected along a second path 204b to the detector. Thus, whereas in the embodiment shown in FIG. 2 the reflective EUV filter 106 is positioned in the illuminator to separate the OOB light such that the OOB light does not propagate downstream, the embodiment shown in FIG. 3 positions the reflective EUV filter at the location of the pupil imager.

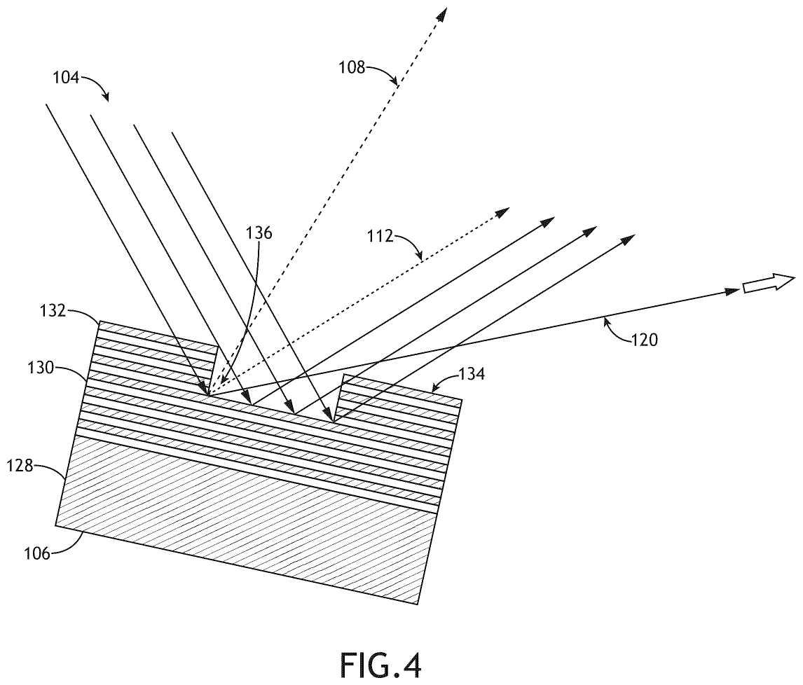

FIG. 4 is a schematic diagram illustrating the concept of filtering performance (e.g., wavelength separation) of the reflective EUV spectral filter 106, in accordance with one or more embodiments of the present disclosure. The reflective EUV spectral filter 106 works in reflection rather than transmission mode and utilizes diffraction that is wavelength sensitive to separate out the 0^{th} order reflection. In use, the EUV illumination beam 104 having a wide wavelength range is filtered such that the extraneous OOB wavelengths 112 are reflected along the 0^{th} order directed along an optical path to a next optic in the system, and the EUV light having a narrow wavelength range (e.g., 10-15 nm, 13.5 nm, etc.) is reflected along the +1^{st} and optionally the higher order to a next optic in the system. In embodiments, the reflective EUV spectral filter 106 may have depths and be angled (e.g., tilted) relative to the incidence angle of the EUV illumination beam 104 such that the 0^{th} order for EUV has destructive interference and more EUV light is directed toward a desired order (e.g., more light directed toward the +1^{st} order than the −1^{st} order).

In embodiments, the reflective EUV spectral filter 106 includes a substrate 128 that may be made from a low thermal expansion material (e.g., quartz, glass), and a multilayer stack 130 disposed on the substrate. The multilayer stack 130 may be configured to reflect the impinging light while having low absorption characteristics of the impinging light. In embodiments, the multilayer stack 130 may include alternating pairs (e.g., 30 to 50 pairs) of molybdenum and silicon layers or other materials having different indices of refraction for causing reflectivity (e.g., beryllium, molybdenum ruthenium, etc.). In embodiments, exposed portions of the multilayer stack 130 may be covered with a capping layer 132 (e.g., ruthenium) to prevent oxidation.

In embodiments, the multilayer stack 130 may be etched to form a diffraction grating, and more specifically, a binary grating patterned to form a plurality of alternating peaks 134 and valleys 136. The grating period (e.g., distance from one peak to the next peak), and the depth of the binary grating (e.g., distance between peak surface level and valley surface level) may be preselected to match the wavelength of the EUV light to be diffracted to the +1^{st} and higher orders. In another embodiment, the grating may be configured to match the wavelength of the extraneous OOB light to be diffracted to a preselected order.

In embodiments, the multilayer grating 130 may include alternating stacks due to the high reflectivity in the +/−1^{st} orders relevant for dispersion. For enhancing the reflectivity within the +/−1^{st} orders, the number of layers of the multilayer stack 130 of either of the phase component (e.g., peak/valley phase tones within a pitch) may be greater than the number of multilayer stacks that saturate EUV reflectivity. Such a configuration may ensure maximum reflectivity from both the tones and may ensure the structure is purely a phase grating (e.g., amplitude modulations may be avoided as they are based on absorptive patterns that degrade diffraction efficiency). Further, the peak to valley depth may be tuned to weaken 0^{th} order intensities, thus transferring EUV photon energies to the +1^{st} and potentially higher orders. For normal incidence, the phase step may be ˜2D/λ, where D is the etch depth into the multilayer stack 130 and λ is the wavelength. The strong phase step at EUV wavelengths for a given etch depth may be optimized to target EUV light; however, should be a weak phase structure for OOB light and hence the OOB light undergoes a weak diffraction unlike the EUV light. Due to 180-degree phase being a modest 13.5 nm/4=˜3.4 nm step between peak and valley in the normal incidence case, OOB light would effectively see the grating as a quasi-flat mirror with near zero amplitude modulation and a weak phase response. As such, most of the OOB light would be reflected into the 0^{th} order. Such a phase grating structure offers multiple desired properties for not just spectrally purifying the EUV content in the 1^{st} and higher orders with a very high efficiency, but also beam splitting the OOB light into the 0^{th} order for use, for example, for illumination beam monitoring.

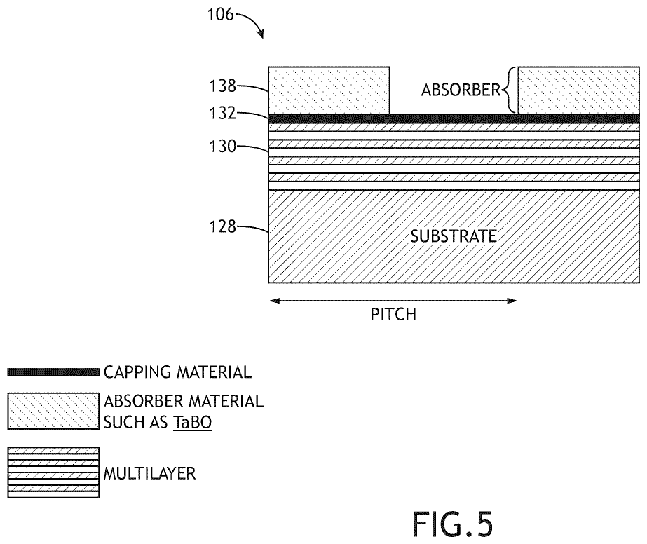

FIG. 5 illustrates a reflective EUV spectral filter 106 according to another embodiment of the present disclosure. In embodiments, the grating structure includes an EUV absorber 138 formed in a grating pattern disposed on the multilayer stack 130. In this embodiment, the grating pattern acts as a hybrid grating that provides both amplitude and phase modulations in the EUV. The alternating intensity variation between the absorber 138 and the multilayer stack leaves non-negligible EUV light in the 0^{th} order. In addition, a portion of the EUV light may be distributed into higher orders depending on pitch and the incident angle. For example, the OOB light behavior may be like a pure phase grating structure, as OOB reflectivity may change little between the EUV absorber 138 and the multilayer stack 130. In this embodiment, the EUV filtering may involve selection of first order beams; however, the 0^{th} order may remain mixed between EUV light and the OOB light thereby realizing a decreased efficiency due to some absorption of EUV light as compared to a pure phase grating. In embodiments, the EUV absorber 138 may include a TaBO or TaBN film topped with a thin anti-reflective oxide, among other absorber layers.

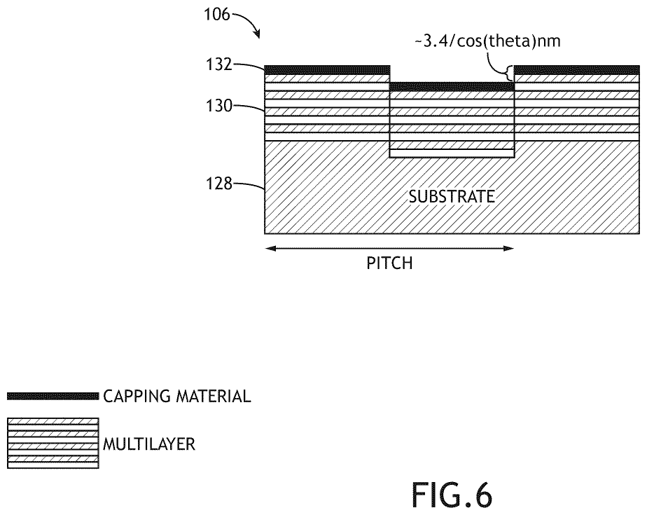

FIG. 6 illustrates a reflective EUV spectral filter 106 according to another embodiment of the present disclosure. In embodiments, the substrate 128 may be first etched to form a grating structure and then the multilayer stack 130 deposited on the etched substrate 128 followed by the capping layer 132 deposited on the multilayer stack 130. In this configuration, the grating structure of the multilayer stack 130 corresponds to the grating structure of the substrate 128. In some embodiments, the grating depth may correspond to a quarter wavelength for the design incident angle (e.g., ˜13.5 nm/4=˜3.4 nm depth for normal incidence), and desired pitch with a duty cycle of 50% into the substrate. In some embodiments, the substrate may be etch blazed. For example, a blaze grating may be etched into the substrate 128 to achieve a 180-degree phase shift for the 0^{th} order for EUV wavelength for the design incident angle and desired pitch with a duty cycle of 50%. The multilayer stack 130 may then be deposited over the etch blazed substrate followed by the capping layer 132 deposited over the multilayer stack 130.

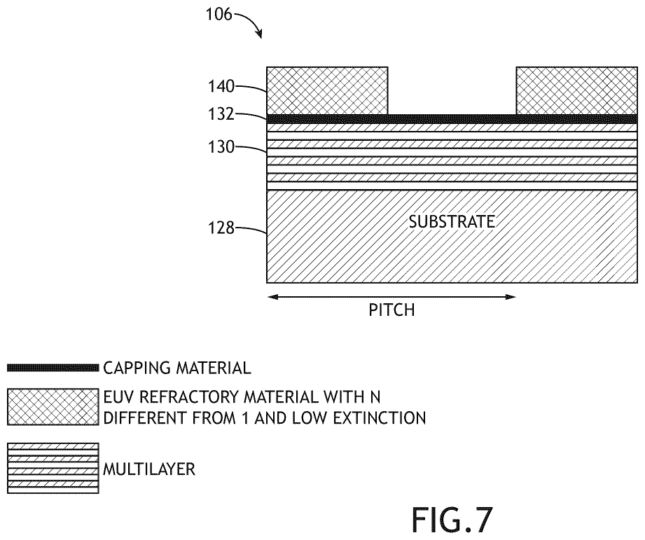

FIG. 7 illustrates the reflective EUV spectral filter 106 according to yet another embodiments of the present disclosure. In embodiments, the reflective EUV spectral filter 106 includes a substrate 128 and a multilayer stack covering the substrate 128, and further includes an EUV refractory material layer 140 deposited on the multilayer stack 130 followed by a capping layer 132. In embodiments, the EUV refractory material may have a refraction coefficient (n) (e.g., less than 1 at 13.5 nm wavelengths) and an extinction coefficient (k) less (e.g., less than 0.04 at 13.5 nm wavelengths) to create phase shift pads. EUV refractory material may include, but is not limited to, molybdenum, ruthenium, rhodium, technetium, niobium, and zirconium. EUV refractory material may be selected based on efficiency (e.g., ratio (1−n)/k being a metric of performance, with higher values being preferable. Preferable materials may have a ratio of 3.5 or higher considering they result in no more than 1/e attenuation on the phase shift pads relative to the spaces. In a particular conceived example, the EUV refractory material is used to create a ˜¼ wavelength phase shift single pass for the desired incident angle.

The reflective EUV spectral filter 106, irrespective of the specific configuration, functions as a mirror and OOB filter in a single element. In embodiments, the OOB light may be confined to within the 0^{th} order by the weak phase/amplitude grating and hence absent in the +1^{st} order distinctively separated from the EUV light in angle within the +1^{st} order. As for the latter, depending on the wavelength, two scenarios may be realized depending on the pitch (p) and wavelength λ of concern. In a first scenario, for pitch p>=λ (irrespective of if the grating has non-negligible amplitude or phase contrast), the light energy may be redistributed into the 1^{st} and higher orders and hence OOB light separated from the 1^{st} order EUV light in angle as θ˜λ/p, or in a second where p<λ, propagate as an evanescent wave leading to no propagating light in the 1^{st} order, which is effectively OOB suppression. Irrespective of which scenario, if the OOB light is separated from the EUV light or suppressed, the filter 106 effectively removes the OOB light from the 1^{st} order EUV light. While OOB suppression/separation schemes may vary in the above-described embodiments, the effectiveness of the process may further depend on the efficiency of the EUV itself being channelized into the 1^{st} order (and potentially to one of the first orders). This to a large extent depends on the energy distribution between the 0^{th} and 1^{st} orders (e.g., phase gratings may achieve this better than amplitude gratings), controlling the angular emission from the underlying multilayer stack (e.g., by optimizing the multilayer stack to skew the maximum energy to the angle of interest), and the application dependent requirements on the desired angle of incidence and angle of the desired +1^{st} order.

In embodiments, the reflective OOB light filtering may work better with narrow and/or low numerical aperture beams that avoid order mixing, whereas wide beams may require larger distances for propagation-based separation of orders. For example, larger numerical aperture beams may require a smaller tighter pitch to achieve a greater angle between the incident beam and the +1^{st} order. Regarding filter fabrication, for pitches of about 100 nm and larger, conventional mask making technology may be used to create the grating structure. For smaller pitches, wafer lithography based on interference lithography techniques or projection lithography techniques may be used to create 20 nm to 50 nm pitch patterns with pattern transfer methods to create tighter pitch gratings.

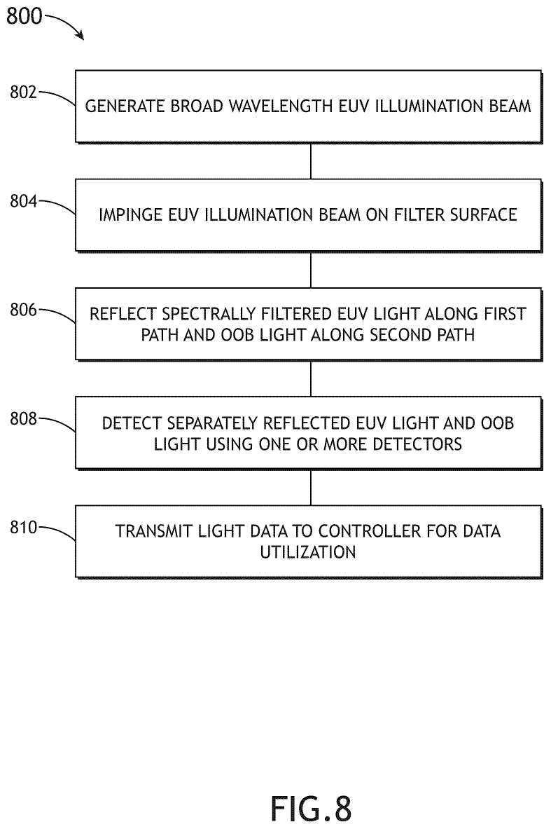

FIG. 8 is a flow chart illustrating a method 800 for spectrally filtering EUV light, in accordance with one or more embodiments of the present disclosure. In step 802, an EUV illumination beam having a broad wavelength range is generated using an EUV light source. In step 804, the EUV illumination beam is impinged on the surface of a reflective EUV filter as described above. In step 806, the diffraction grating structure provided on the reflective filter causes the broad wavelength EUV illumination beam to separate into spectrally filtered EUV light (e.g., 10-15 nm) reflected along a first optical path, and OOB light (e.g., longer wavelengths) reflected along a second optical path. In step 808, the spectrally filtered EUV light reflected along the first optical path is detected by one or more first detectors (e.g., image sensor) and the OOB light reflected along the second optical path is detected by one or more second detectors. In some embodiments, the spectrally filtered EUV light reflected along the first optical path, before being detected by the one or more first detectors, may be directed to one or more downstream optics used to illuminate a target substrate, for a lithographic process, for obtaining an image, etc. In step 810, data associated with the detected EUV light and OOB light is received by a controller configured to utilize the data for a preselected purpose (e.g., metrology, defect detection, light source performance/health, etc.). In embodiments, the data may be used separately or collectively.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. A reflective imaging system comprising:
an illumination source configured to generate an extreme ultraviolet (EUV) illumination beam;
a reflective spectral filter configured to receive the EUV illumination beam and spectrally filter the received EUV illumination beam by reflecting spectrically filtered EUV light along a first optical path and reflecting out-of-band (OOB) light along a second optical path;
one or more first detectors positioned in an image plane of the first optical path configured to detect the spectrally filtered EUV light;
one or more second detectors positioned in an image plane of the second optical path configured to detect the OOB light; and
a controller communicatively coupled to the one or more first detectors and the one or more second detectors, the controller including one or more processors configured to receive data pertaining to the detected spectrally filtered EUV light and the detected OOB light.

2. The reflective imaging system of claim 1, wherein the first optical path corresponds to the +1^{st} order and the second optical path corresponds to the 0^{th} order.

3. The reflective imaging system of claim 1, wherein the first path is directed to at least one of a downstream optic, a further reflective spectral filter, and a target substrate to be illuminated by the spectrally filtered EUV light.

4. The reflective imaging system of claim 1, wherein the reflective spectral filter is angled relative to an incident angle of the EUV illumination beam.

5. The reflective imaging system of claim 1, wherein the reflective spectral filter comprises a substrate, a multilayer stack disposed on the substrate, and a capping material disposed on the multilayer stack.

6. The reflective imaging system of claim 5, wherein the multilayer stack comprises alternating pairs of molybdenum and silicon layers.

7. The reflective imaging system of claim 5, wherein the multilayer stack comprises a binary grating having a preselected depth and preselected pitch.

8. The reflective imaging system of claim 5, further comprising an absorber layer disposed on the multilayer stack, the absorber layer having a binary grating having a preselected depth and preselected pitch.

9. The reflective imaging system of claim 5, wherein the substrate has a binary grating grating having a preselected depth and preselected pitch, and the multilayer stack has a binary grating matching the binary grating of the substrate.

10. The reflective imaging system of claim 5, further comprising EUV refractory material disposed on the multilayer stack, the EUV refractory material having a binary grating having a preselected depth and preselected pitch.

11. The reflective imaging system of claim 5, wherein the reflective spectral filter comprises a diffraction grating having a blazed-phase configuration.

12. A method for spectrally filtering extreme ultraviolet (EUV) light, the method comprising:
receiving, by a reflective spectral filter, EUV light from an EUV illumination beam;
separating, by the reflective spectral filter, the EUV light into spectrally filtered EUV light and out-of-band (OOB) light;
reflecting, by the reflective spectral filter, the spectrally filtered EUV light along a first optical path and the OOB light along a second optical path;
detecting, by at least one first detector positioned in an image plane of the first optical path, the EUV light reflected along the first optical path; and
detecting, by at least one second detector positioned in an image plane of the second optical path, the OOB light reflected along the second optical path.

13. The method of claim 12, further comprising:
receiving, by a controller communicatively coupled to the at least one second detector, data pertaining the OOB light reflected along the second optical path.

14. The method of claim 12, further comprising:
directing the spectrally filtered EUV light to at least one of a downstream optic, a further reflective spectral filter, and a target substrate, wherein the target substrate is configured to by illuminated by the spectrally filtered EUV light and reflect the spectrally filtered EUV light to be detected by the at least one first detector.

15. The method of claim 14, further comprising:
determining, by a controller communicatively coupled to the at least one first detector, a presence or absence of at least one of an alignment error and a defect based on a image of the target substrate.

16. The method of claim 12, wherein the first optical path corresponds to the +1^{st} order and the second optical path corresponds to the 0^{th} order.

17. The method of claim 12, wherein the reflective spectral filter is angled relative to an incident angle of the EUV illumination beam.

18. The method of claim 12, wherein the reflective spectral filter comprises a substrate, a multilayer stack disposed on the substrate, and a capping material disposed on the multilayer stack, and wherein the multilayer stack comprises a binary grating having a preselected depth and preselected pitch configured to reflect the spectrally filtered EUV light along the first optical path and reflect the OOB light along the second optical path.

19. The method of claim 12, wherein the reflective spectral filter further comprises an absorber layer disposed on the multilayer stack, the absorber layer having a binary grating having a preselected depth and preselected pitch.

20. A reflective spectral filter configured to spectrally separate out-of-band (OOB) light from a plasma extreme ultraviolet (EUV) illumination beam, comprising:
a substrate;
a multilayer stack positioned on the substrate; and
a capping layer positioned on the multilayer stack;
wherein at least one of the substrate and the multilayer stack comprises a binary grating having a preselected depth and preselected pitch configured to reflect spectrally filtered EUV light along a first optical path and reflect the OOB light along a second optical path.

21. The reflective spectral filter of claim 20, wherein the first optical path corresponds to the +1^{st} order and the second optical path corresponds to the 0^{th} order.

22. The reflective spectral filter of claim 20, wherein the multilayer stack comprises alternating pairs of molybdenum and silicon.

23. The reflective spectral filter of claim 20, further comprising an absorber layer disposed on the multilayer stack, the absorber layer having a binary grating having a preselected depth and preselected pitch.

24. The reflective spectral filter of claim 20, further comprising EUV refractory material disposed on the multilayer stack, the EUV refractory material having a binary grating having a preselected depth and preselected pitch.
